(19) United States
(12) Patent Application Publication
(10) Pub. No.: US 2015/0153210 A1
(43) Pub. Date: Jun. 4, 2015

(54) FUEL DISPENSER CORIOLIS FLOW METER

(71) Applicant: Gilbarco Inc., Greensboro, NC (US)

(72) Inventors: Jack Francis Bartlett, Summerfield, NC (US); Brent K. Price, Kernersville, NC (US); Andrew R. Krochmal, Greensboro, NC (US)

(21) Appl. No.: 14/559,957

(22) Filed: Dec. 4, 2014

Related U.S. Application Data
(60) Provisional application No. 61/911,729, filed on Dec. 4, 2013.

(51) Int. Cl. G01F 1/84; B67D 7/16; B67D 7/04

(52) U.S. Cl. CPC G01F 1/849; B67D 7/04; B67D 7/16

(57) ABSTRACT

A Coriolis flow meter having a first end structure, a second end structure, and a flow path extending therebetween. The first and second end structures are connectable with a conduit such that fluid flowing in the conduit enters at one of the first and second end structures, travels along the flow path, and exits at the other of the first and second end structures. The flow path has a measurement tube having first and second ends and a damper assembly. The damper assembly has at least one damper element disposed between the first end structure and the measurement tube first end. The measurement tube is not fixed with respect to the first end structure. At least one transducer is coupled with the measurement tube and is operative to sense vibration of the measurement tube and output electrical signals representative thereof.

### PRIORITY CLAIM

This application claims the benefit of U.S. Provisional Application Ser. No. 61/911,729, titled “Fuel Dispenser Coriolis Flow Meter,” filed Dec. 4, 2013, which is hereby relied upon and incorporated herein by reference for all purposes.

### BACKGROUND

The present invention relates generally to fuel dispensing equipment. More specifically, embodiments of the present invention relate to a fuel dispenser including a Coriolis flow meter.

Fuel dispensers typically include one or more flow meters to accurately measure the amount of fuel being delivered to the customer's vehicle. Typically, such flow meters must comply with weights and measures regulatory requirements that require a high level of accuracy. A number of different flow meters are known in the art for measuring fuel flow rate through a fuel dispenser. Typically, either positive displacement meters or inferential meters have been used for this purpose.

However, for a variety of reasons, fuel volume or flow rate measurement technologies are typically limited in their measurement accuracies across a finite range of flow rates. Additionally, these measurement technologies may be limited in their maximum flow rates at the desired, restricted-to, and/or otherwise realistic operating pressures by internal restrictions or fluidic impedances, including but not limited to bore, port, or other orifice size. Moreover, these measurement technologies require periodic recalibration and/or special filters.

Flow meters utilizing the Coriolis Effect to measure the mass flow rate of a fluid are also known in the fluid flow measurement art. Generally, in such Coriolis meters an electromechanical actuator forces one or more fluid-filled flow tubes to vibrate in a prescribed oscillatory bending-mode of vibration. When the process-fluid is flowing, the combination of fluid motion and tube vibration causes inertial forces which deflect the tubes away from their normal paths of vibration in a manner that is proportionally related to mass flow rate. Motion of the tube is measured at one or more specific locations along its length, and this information is used to determine mass flow. The tube(s) can have various configurations, including S-, V-, and U-shaped configurations. Additionally, Coriolis flow meters are known which have tube(s) in a straight configuration. Detailed information on the structure and operation of traditional Coriolis flow meters is disclosed in U.S. Pat. Nos. 7,287,438; 7,472,606; 6,415,668; and 5,814,739, the entire disclosures of which are incorporated by reference herein in their entireties for all purposes.

Current Coriolis metering technology has several desirable characteristics over positive displacement and inferential flow meters. For instance, Coriolis meters are highly accurate, they are not subject to wear or meter drift because they lack internal moving parts, they can measure flow in forward and backward directions, and they measure fluid mass directly. Some implementations also measure fluid density directly. Thus, it has been proposed to use Coriolis flow meters in fuel dispensing environments. In this regard, see U.S. Pat. No. 8,342,199, the entirety of which is incorporated by reference herein in its entirety for all purposes.

### SUMMARY

The present invention recognizes and addresses various considerations of prior art constructions and methods. According to one embodiment, the present invention provides a Coriolis flow meter for measuring characteristics of a fluid flowing in a conduit. The flow meter comprises a first end structure and a second end structure. The flow meter also comprises a flow path extending between the first end structure and the second end structure. The first and second end structures are connectable with the conduit such that the fluid flowing in the conduit enters the flow meter at one of the first and second end structures, travels along the flow path, and exits the flow meter at the other of the first and second end structures. The flow path comprises at least one measurement tube having a first end and a second end. The flow path further comprises a damper assembly comprising at least one damper element disposed between the first end structure and the at least one measurement tube first end such that the at least one measurement tube is not fixed with respect to the first end structure. The flow meter also comprises at least one transducer coupled with the at least one measurement tube. The at least one transducer is operative to sense vibration of the at least one measurement tube and output electrical signals representative thereof.

According to a further embodiment, the present invention provides a fuel dispenser. The fuel dispenser comprises internal fuel flow piping adapted for connection to a source of fuel from a bulk storage tank to a nozzle and at least one fuel flow meter located along the fuel flow piping. The at least one fuel flow meter comprises a first end structure and a second end structure. The at least one fuel flow meter also comprises a flow path extending between the first end structure and the second end structure. The flow path comprises at least one measurement tube. The flow path further comprises a damper assembly disposed between the first end structure and the at least one measurement tube such that the at least one measurement tube is not fixed with respect to the first end structure. The at least one fuel flow meter further comprises at least one transducer coupled with the at least one measurement tube. The at least one transducer is operative to sense vibration of the at least one measurement tube and output electrical signals representative thereof. The fuel dispenser also comprises a control system having a processor in electrical communication with the at least one transducer of the at least one fuel flow meter.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

A full and enabling disclosure of the present invention, including the best mode thereof directed to one skilled in the art, is set forth in the specification, which makes reference to the appended drawings, in which:

FIG. 1 is a diagrammatic representation of a retail fuel dispensing environment in which an embodiment of the present invention may be utilized.

FIG. 2 is a perspective view of an exemplary fuel dispenser that may operate within the retail fueling environment of FIG. 1.

FIG. 3 is a schematic illustration of internal fuel flow components of a fuel dispensing system including the dispenser of FIGS. 1 and 2 and the underground storage tank of FIG. 1 according to an embodiment of the present invention.

FIG. 4 is a schematic side view of a prior art, dual straight tube Coriolis flow meter, shown in partial cross section.

FIG. 5 is a perspective view of a Coriolis flow meter, shown in partial cross section, comprising a damper assembly in accordance with one embodiment of the present invention.

FIG. 6 is a block diagram illustrating measurement electronics of the Coriolis flow meter of FIG. 5.

FIG. 7 is a perspective view of a Coriolis flow meter, shown in partial cross section, comprising a damper assembly in accordance with another embodiment of the present invention.

FIG. 8 is a partial cross section of the damper assembly of the Coriolis flow meter of FIG. 7.

FIG. 9 is an enlarged perspective view of the damper assembly and measurement tubes of the Coriolis flow meter of FIG. 7.

FIG. 10 is a perspective view of a Coriolis flow meter, shown in partial cross section, comprising a damper assembly in accordance with a further embodiment of the present invention.

FIG. 11 is a partial cross section of the damper assembly of the Coriolis flow meter of FIG. 10.

FIG. 12 is an enlarged perspective view of the damper assembly and measurement tubes of the Coriolis flow meter of FIG. 10.

FIG. 13 is an enlarged perspective view of a damper assembly and measurement tubes of a Coriolis flow meter according to a further embodiment of the present invention.

FIG. 14 is a partial cutaway view of a Coriolis flow meter in accordance with an embodiment of the present invention.

FIG. 15 is an exploded view of the Coriolis flow meter of FIG. 14.

FIG. 16 is an enlarged view of the outer face of an end plate of the Coriolis flow meter of FIG. 14.

FIG. 17 is an enlarged view of the inner face of the end plate of FIG. 16.

FIG. 18 is an enlarged perspective view of the damper assembly and measurement tubes of a Coriolis flow meter according to a further embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

Some embodiments of the present invention may be particularly suitable for use with a fuel dispenser in a retail service station environment, and the below discussion will describe some preferred embodiments in that context. However, those of skill in the art will understand that the present invention is not so limited. In fact, it is contemplated that embodiments of the present invention may be used with any appropriate application where it may be desirable to accurately measure characteristics of fluid flow, including flow of a variety of liquids and gases. For example, embodiments of the present invention may also be used with diesel exhaust fluid (DEF) dispensers, compressed natural gas (CNG) dispensers, and liquefied petroleum gas (LPG) and liquid natural gas (LNG) applications, among others.

Moreover, though several preferred embodiments are described with respect to a dual straight tube Coriolis flow meter, it will be appreciated that embodiments of the present invention may be used with flow meters having flow measurement tubes of various configurations. For example, embodiments of the present invention may also be used in straight tube Coriolis flow meters having a single straight tube surrounded by a balance tube. Further, embodiments of the present invention may be used in Coriolis flow meters having curved or bent measurement tubes.

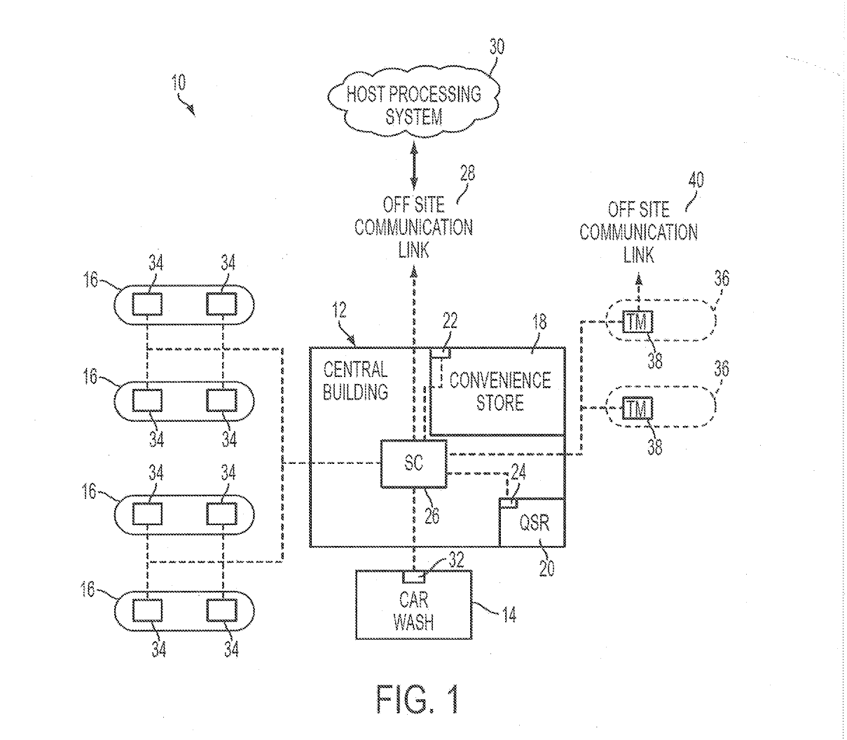

Referring now to FIG. 1, an exemplary fueling environment 10 may comprise a central building 12, a car wash 14, and a plurality of fueling islands 16. The central building 12 need not be centrally located within the fueling environment 10, but rather is the focus of the fueling environment 10, and may house a convenience store 18 and/or a quick serve restaurant 20 therein. Both the convenience store 18 and the quick serve restaurant 20 may include a point of sale (POS) 22, 24, respectively. POS 22, 24 may comprise a single computer or server operatively connected to an associated card reader and payment terminal. Additionally, POS 22, 24 may include a display, a touch screen, and/or other input devices.

The central building 12 may further house a site controller (SC) 26, which in an exemplary embodiment may be the PASSPORT® POS system, sold by Gilbarco Inc. of Greensboro, N.C., although third party site controllers may be used. Site controller 26 may control the authorization of fueling transactions and other conventional activities as is well understood, and site controller 26 may preferably be in operative communication with each POS. Alternatively, site controller 26 may be incorporated into a POS, such as point of sale 22 if needed or desired.

Further, site controller 26 may have an off-site communication link 28 allowing communication with a remote host processing system 30 for credit/debit card authorization, content provision, reporting purposes or the like, as needed or desired. In one embodiment, communication link 28 may be a stand alone router, switch, or gateway, although it should be appreciated that site controller 26 may additionally perform the functions of, and therefore replace, such a device. The off-site communication link 28 may be routed through the Public Switched Telephone Network (PSTN), the Internet, both, or the like, as needed or desired. Remote host processing system 30 may comprise at least one server maintained by a third party, such as a financial institution. Although only one remote host processing system 30 is illustrated, those of skill in the art will appreciate that in a retail payment system allowing payment via payment devices issued by multiple payment card companies or financial institutions, site controller 26 may be in communication with a plurality of remote host processing systems 30.

Car wash 14 may have a POS 32 associated therewith that communicates with site controller 26 for inventory and/or sales purposes. Car wash 14 alternatively may be a stand alone unit. Note that car wash 14, convenience store 18, and quick serve restaurant 20 are all optional and need not be present in a given fueling environment.

Fueling islands 16 may have one or more fuel dispensers 34 positioned thereon. Fuel dispensers 34 may be similar to, for example, the ENCORE® dispenser sold by Gilbarco Inc. of Greensboro, N.C. but modified for use with the present invention as described herein. Fuel dispensers 34 are in electronic communication with site controller 26 through any suitable link, such as two wire, RS 422, Ethernet, wireless, etc. as needed or desired.

Fueling environment 10 also has one or more underground storage tanks (USTs) 36 adapted to hold fuel therein. As such, USTs 36 may each be a double walled tank. Further, each UST 36 may include a tank monitor (TM) 38 associated therewith. Tank monitors 38 may communicate with fuel dispensers 34 (either through site controller 26 or directly, as needed or desired) to determine amounts of fuel dispensed and compare fuel dispensed to current levels of fuel within USTs 36 to determine if USTs 36 are leaking.

Tank monitor 38 may communicate with site controller 26 and further may have an off-site communication link 40 for leak detection reporting, inventory reporting, or the like. Much like off-site communication link 28, off-site communication link 40 may be through the PSTN, the Internet, both, or the like. If off-site communication link 28 is present, off-site communication link 40 need not be present and vice versa, although both links may be present if needed or desired.

Further information on and examples of fuel dispensers and retail fueling environments are provided in U.S. Pat. Nos. 6,435,204; 5,956,259; 5,734,851; 6,052,629; 5,689,071; 6,935,191; and 7,289,877, all of which are incorporated herein by reference in their entireties for all purposes. An exemplary tank monitor 38 may be the TLS-450 manufactured and sold by the Veeder-Root Company of Simsbury, Conn. For more information about tank monitors and their operation, reference is made to U.S. Pat. Nos. 5,423,457; 5,400,253; 5,319,545; and 4,977,528, all of which are incorporated by reference herein in their entireties for all purposes.

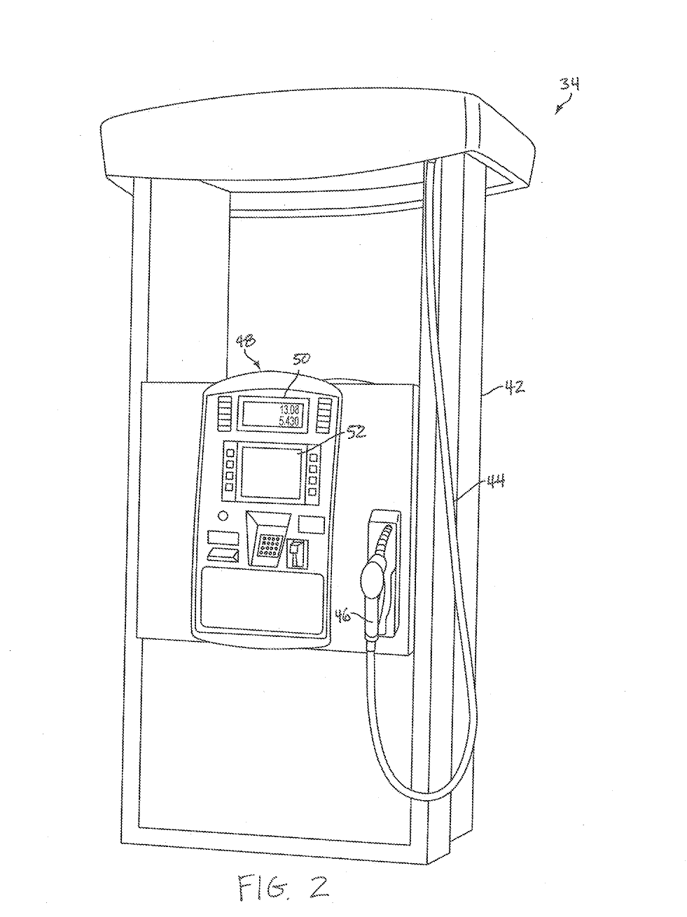

FIG. 2 is a perspective view of an exemplary fuel dispenser 34 that may operate within the fueling environment 10 of FIG. 1. Fuel dispenser 34 includes a housing 42 with a flexible fuel hose 44 extending therefrom. Fuel hose 44 terminates in a manually-operated nozzle 46 adapted to be inserted into a fill neck of a vehicle's fuel tank. Nozzle 46 includes a fuel valve. Various fuel handling components, such as valves and meters, are also located inside of housing 42. These fuel handling components allow fuel to be received from underground piping and delivered through hose 44 and nozzle 46 to a vehicle's tank, as is well understood.

Fuel dispenser 34 has a customer interface 48. Customer interface 48 may include an information display 50 relating to an ongoing fueling transaction that includes the amount of fuel dispensed and the price of the dispensed fuel. Further, customer interface 48 may include a media display 52 to provide advertising, merchandising, and multimedia presentations to a customer in addition to basic transaction functions. The graphical user interface provided by the dispenser allows customers to purchase goods and services other than fuel at the dispenser.

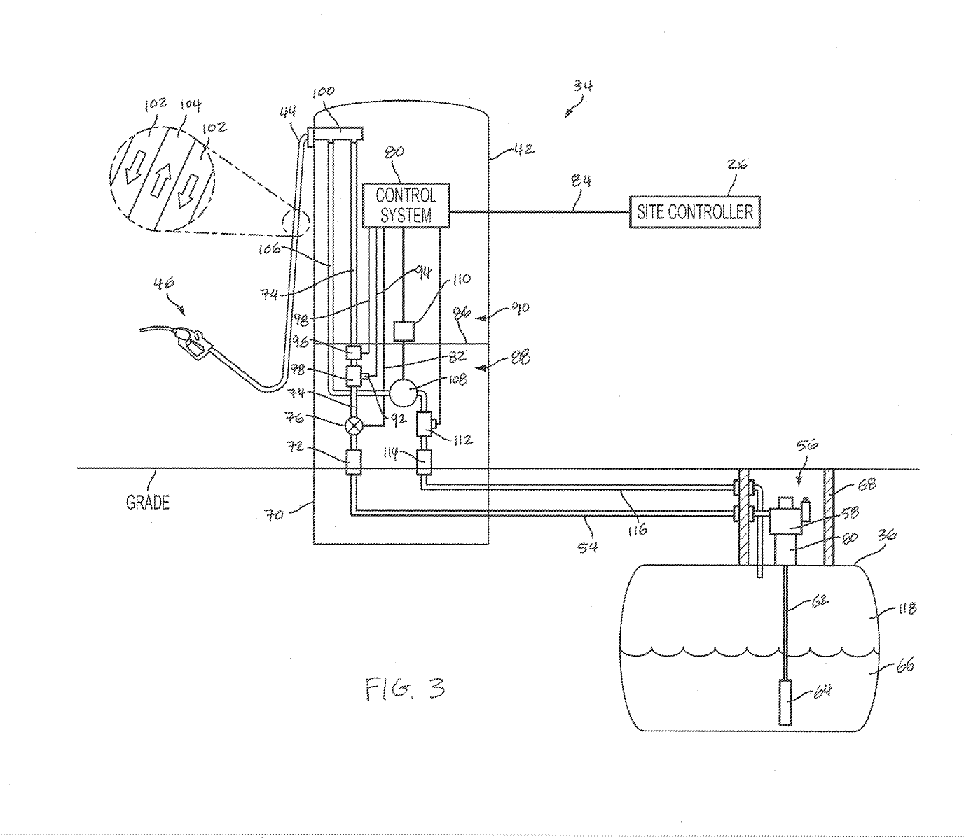

FIG. 3 is a schematic illustration of internal fuel flow components of a fuel dispensing system, including a fuel dispenser 34 and a UST 36, according to an embodiment of the present invention. In general, fuel may travel from a UST 36 via main fuel piping 54, which may be a double-walled pipe having secondary containment as is well known, to fuel dispenser 34 and nozzle 46 for delivery. An exemplary underground fuel delivery system is illustrated in U.S. Pat. No. 6,435,204, hereby incorporated by reference in its entirety for all purposes.

More specifically, a submersible turbine pump (STP) 56 associated with the UST 36 is used to pump fuel to the fuel dispenser 34. However, some fuel dispensers may be self-contained, meaning fuel is drawn to the fuel dispenser 34 by a pump controlled by a motor positioned within housing 42.

STP 56 is comprised of a distribution head 58 containing power and control electronics that provide power through a riser 60 down to a boom 62 inside the UST 36, eventually reaching a turbine pump contained inside an outer turbine pump housing 64. STP 56 may preferably be the RED JACKET® submersible turbine pump, manufactured by the Veeder-Root Co. of Simsbury, Conn. Also, STP 56 may contain a siphon that allows the STP 56 to generate a vacuum using the force of fuel flow. In addition, riser pipe 60 and distribution head 58 may preferably be secondarily contained to capture and monitor leaks. For example, such a system is disclosed in U.S. Pat. No. 7,010,961, hereby incorporated by reference in its entirety for all purposes. As noted above, there may be a plurality of USTs 36 and STPs 56 in a service station environment if more than one type or grade of fuel 66 is to be delivered by a fuel dispenser 34.

The turbine pump operates to draw fuel 66 upward from the UST 36 into the boom 62 and riser 60 for delivery to the fuel dispenser 34. After STP 56 draws the fuel 66 into the distribution head 58, the fuel 66 is carried through STP sump 68 to main fuel piping 54. Main fuel piping 54 carries fuel 66 through dispenser sump 70 to the fuel dispenser 34 for eventual delivery. Those of skill in the art will appreciate that dispenser sump 70, which may also be double-walled, is adapted to capture any leaked fuel 66 that drains from fuel dispenser 34 and its fuel handling components so that fuel 66 is not leaked into the ground.

Main fuel piping 54 may then pass into housing 42 through a product line shear valve 72. As is well known, product line shear valve 72 is designed to close the fuel flow path in the event of an impact to fuel dispenser 34. U.S. Pat. No. 8,291,928, hereby incorporated by reference in its entirety for all purposes, discloses an exemplary secondarily-contained shear valve adapted for use in service station environments. Product line shear valve 72 contains an internal fuel flow path to carry fuel 66 from main fuel piping 54 to internal fuel piping 74, which may also be double-walled.

After fuel 66 exits the outlet of shear valve 72 and enters into internal fuel piping 74, it may encounter a flow control valve 76 positioned upstream of a flow meter 78. In some prior art fuel dispensers, valve 76 may be positioned downstream of the flow meter 78. In one embodiment, valve 76 may be a proportional solenoid controlled valve, such as described in U.S. Pat. No. 5,954,080, hereby incorporated by reference in its entirety for all purposes.

Flow control valve 76 is under control of a control system 80 via a flow control valve signal line 82. In this manner, control system 80 can control the opening and closing of flow control valve 76 to either allow fuel to flow or not flow through meter 78 and on to the hose 44 and nozzle 46. Control system 80 may be any suitable electronics with associated memory and software programs running thereon whether referred to as a processor, microprocessor, controller, microcontroller, or the like. In a preferred embodiment, control system 80 may be comparable to the microprocessor-based control systems used in CRIND and TRIND type units sold by Gilbarco Inc. Control system 80 typically controls other aspects of fuel dispenser 34, such as valves, displays, and the like as is well understood. For example, control system 80 typically instructs flow control valve 76 to open when a fueling transaction is authorized. In addition, control system 80 may be in electronic communication with site controller 26 via a fuel dispenser communication network 84. Site controller 26 communicates with control system 80 to control authorization of fueling transactions and other conventional activities.

The memory of control system 80 may be any suitable memory or computer-readable medium as long as it is capable of being accessed by the control system, including random access memory (RAM), read-only memory (ROM), erasable programmable ROM (EPROM), or electrically EPROM (EEPROM), CD-ROM, DVD, or other optical disk storage, solid-state drive (SSD), magnetic disc storage, including floppy or hard drives, any type of suitable non-volatile memories, such as secure digital (SD), flash memory, memory stick, or any other medium that may be used to carry or store computer program code in the form of computer-executable programs, instructions, or data. Control system 80 may also include a portion of memory accessible only to control system 80.

Flow control valve 76 is contained below a vapor barrier 86 in a hydraulics compartment 88 of fuel dispenser 34. Control system 80 is typically located in an electronics compartment 90 of fuel dispenser 34 above vapor barrier 86. After fuel 66 exits flow control valve 76, it typically flows through meter 78, which preferably measures the flow rate, density, and temperature of fuel 66.

As described in more detail below, flow meter 78 may preferably be a Coriolis mass flow meter. Meter 78 typically comprises electronics 92 that communicates information representative of the mass flow rate, density, and temperature of fuel to control system 80 via a signal line 94. In this manner, control system 80 can update the total gallons (or liters) dispensed and the price of the fuel dispensed on information display 50.

As fuel leaves flow meter 78 it enters a flow switch 96. Flow switch 96, which is preferably a one-way check valve that prevents rearward flow through fuel dispenser 34, generates a flow switch communication signal via flow switch signal line 98 to control system 80 to communicate when fuel 66 is flowing through flow meter 78. The flow switch communication signal indicates to control system 80 that fuel is actually flowing in the fuel delivery path and that subsequent signals from flow meter 78 are due to actual fuel flow.

After fuel 66 enters flow switch 96, it exits through internal fuel piping 74 to be delivered to a blend manifold 100. Blend manifold 100 receives fuels of varying octane levels from the various USTs and ensures that fuel of the octane level selected by the customer is delivered. After flowing through blend manifold 100, fuel 66 passes through fuel hose 44 and nozzle 46 for delivery to the customer's vehicle.

In this case, fuel dispenser 34 comprises a vapor recovery system to recover fuel vapors through nozzle 46 and hose 44 to return to UST 36. An example of a vapor recovery assist equipped fuel dispenser is disclosed in U.S. Pat. No. 5,040,577, incorporated herein in its entirety for all purposes. More particularly, flexible fuel hose 44 is coaxial and includes a product delivery line 102 and a vapor return line 104. Both lines 102 and 104 are fluidly connected to UST 36 through fuel dispenser 34. Lines 102 and 104 diverge internal to dispenser 34 at manifold 100, such that product delivery line 102 is fluidly coupled to internal fuel piping 74 and vapor return line 104 is fluidly coupled to internal vapor return piping 106. During delivery of fuel into a vehicle's fuel tank, the incoming fuel displaces air in the fuel tank containing fuel vapors. Vapor may be recovered from the vehicle's fuel tank through vapor return line 104 and returned to UST 36 with the assistance of a vapor pump 108. A motor 110 may operate vapor pump 108. Internal vapor return piping 106 is coupled to a vapor flow meter 112. Vapor flow meter 112, which measures vapor collected by the nozzle 46 when fuel 66 is dispensed, may be used for in-station diagnostics and monitoring or control of vapor recovery. In some preferred embodiments, vapor flow meter 112 may also be a Coriolis mass flow meter.

After the recovered vapor passes through vapor flow meter 112, the recovered vapor passes to vapor line shear valve 114 (which may be analogous to product line shear valve 72). Finally, the recovered vapor returns to UST 36 via vapor return piping 116. Vapor return piping 116 is fluidly coupled to the ullage 118 of UST 36. Thus, the recovered vapor is recombined with the vapor in ullage 118 to prevent vapor emissions from escaping to the atmosphere. The vapors recombine and liquefy into fuel 66.

As noted above, flow meter 78 may preferably be a Coriolis mass flow meter. Importantly, however, Coriolis flow meters are only highly accurate where the deflection of the tube(s) away from their normal paths of vibration is due solely to the generated inertial forces. Where other, extraneous forces affect the deflection of the tube(s), errors in flow measurement result. These problems have made prior art Coriolis flow meters less suitable for use for certain applications, including fuel dispensing applications.

More particularly, pumps, nozzles, valves, and other equipment connected with the process piping can cause extraneous vibrations which can couple with the forces induced on the tube(s) in the flow meter (i.e., the forced vibrations and the inertial forces), causing measurement error. Additionally, differences in operating temperatures or coefficients of thermal expansion of various portions of the flow meter can cause extraneous stresses which generate axial tension on or compression of the tube(s). Axial tension may stiffen the tube(s), making them less responsive to the induced inertial forces, and axial compression may soften the tube(s), making them more responsive to the induced inertial forces.

One response to the problem of extraneous forces in straight tube Coriolis flow meters has been to make the support structures for the tube(s) (e.g., such as the end caps or bases) extremely rigid and heavy so that forces generated by externally applied loads are transferred to the support structures, rather than to the tube(s) themselves. Although this approach is somewhat effective in isolating the tube(s) from external forces, this approach increases both the cost and complexity of manufacture. Moreover, the rigidity of the support structures does not solve, and may in fact exacerbate, the problem of thermally-induced stresses. Indeed, the axial stresses in such cases can exceed the yield stress of the tube material, causing the tubes to deform, tear, or separate from the rigid support structures. Attempts have been made to design tube configurations with irregular shapes which naturally reduce strain, but these likewise increase the cost and complexity of manufacture.

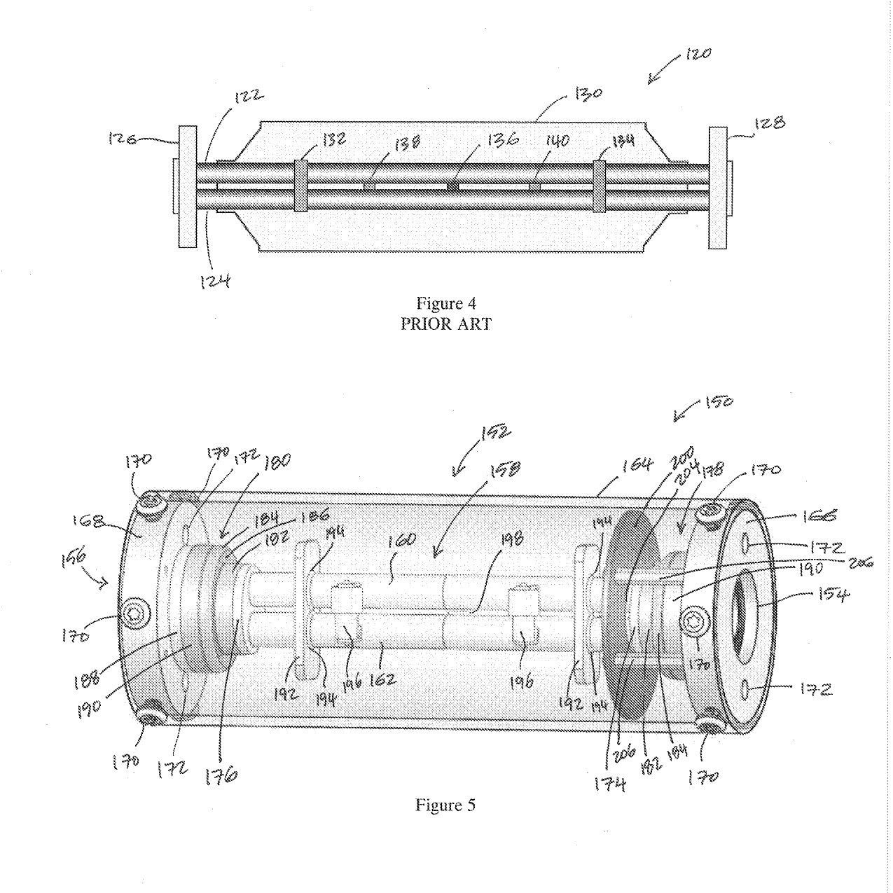

In this regard, FIG. 4 is a schematic partial cross section of a prior art, dual straight tube Coriolis flow meter 120. Flow meter 120 comprises generally parallel measurement tubes 122, 124 which each extend between an inlet manifold 126 and an outlet manifold 128. Manifolds 126, 128 are typically adapted for connection to a conduit (not shown) through which the fluid to be measured flows. Manifold 126 also divides entering fluid flow uniformly between measurement tubes 122, 124, for example by a flow divider. Correspondingly, manifold 128 combines the flow exiting measurement tubes 122, 124 so that the combined flow may continue into the conduit. Measurement tubes 122, 124 may be partially surrounded by a housing 130.

Flow meter 120 also comprises brace bars 132, 134 coupled with measurement tubes 122, 124. Brace bars 132, 134 are spaced apart along measurement tubes 122, 124 at equal distances from manifolds 126 and 128, respectively. Brace bars 132, 134 may each comprise a flat plate having two apertures therein and through which each measurement tube 122, 124 is passed and secured. Between and coupled with measurement tubes 122, 124 are an actuator 136 and two transducers 138, 140. Transducers 138, 140 may each be disposed an equal lateral distance from brace bars 132, 134, and actuator 136 may be centered with respect to brace bars 132, 134. In general, actuator 136 may comprise an electromagnet coupled with one of measurement tubes 122, 124 and a corresponding armature coupled with the other of measurement tubes 122, 124 configured to excite measurement tubes 122, 124 in a periodic fashion. Transducers 138, 140 may measure either the velocity or displacement of measurement tubes 122, 124 when measurement tubes 122, 124 are excited by actuator 136. Those of skill in the art are familiar with suitable actuators and transducers for this purpose.

The operation of the prior art Coriolis flow meter 120 should be familiar to those skilled in the art. In general, an alternating current may be applied to actuator 136 to cause measurement tubes 122, 124 to vibrate in a prescribed mode of vibration, such as the first bending mode of vibration. Transducers 138, 140 sense the mechanical vibrations of measurement tubes 122, 124 and output electrical signals representative of the motion (e.g., velocity or displacement) thereof. When fluid is flowing through meter 120, the vibrations of measurement tubes 122, 124 impart Coriolis acceleration to the flowing fluid. This acceleration results in inertial reaction forces on measurement tubes 122, 124, causing measurement tubes 122, 124 to deflect away from their normal modes of vibration. Correspondingly, this deflection results in a time or phase delay between the signals output by transducers 138, 140.

The mass flow rate of the flowing fluid is proportional to the time or phase delay between these signals. These signals are output to suitable electronics, which may calculate the mass flow rate of the fluid. If flow meter 120 is also able to determine the density of the fluid, the electronics may also determine the volumetric flow rate by dividing the mass flow rate by the density. Those of skill in the art are familiar with the measurement of density using a Coriolis flow meter, and thus the density measurement is not described in detail herein. In general, however, the natural frequency of vibration of measurement tubes 122, 124 depends upon the combined mass of the tubes 122, 124 themselves and the mass of the fluid contained therein. Thus, where the volume of tubes 122, 124 is known, the density of the fluid may be determined by dividing the mass of the fluid contained in tubes 122, 124 by the known volume.

As shown, measurement tubes 122, 124 are directly coupled with manifolds 126, 128. Thus, extraneous forces from equipment fluidly coupled with the conduits attached to manifolds 126, 128 can be coupled with the forces induced on measurement tubes 122, 124 by actuator 136 and the inertial forces. As explained above, this may cause measurement error. In the past, manifolds 126, 128 have been formed of an extremely rigid material so that forces generated by externally applied loads are transferred thereto, rather than to the tubes 122, 124 themselves. Also, brace bars 132, 134 may further isolate the sections of tubes 122, 124 between brace bars 132, 134 from extraneous forces by providing a pivot point for the motion of tubes 122, 124 under the forces induced by actuator 136 and the inertial forces. Finally, prior art solutions to this problem have also included flexible hoses attached directly upstream and downstream of flow meter 120, thus separating flow meter 120 from a rigid conduit.

Also as explained above, however, thermally-induced stresses generate axial tension or compression of tubes 122, 124. Thermally-induced stresses may occur where different portions of flow meter 120, such as manifolds 126, 128 and measurement tubes 122, 124, have the same temperature, but are formed of different materials with different coefficients of thermal expansion. Further, such stresses may occur where different portions of flow meter 120 have different temperatures. This may be the case, for example, where the temperature of the fluid being measured is different than the ambient temperature. In any case, neither the rigidity of manifolds 126, 128 nor brace bars 132, 134 are suitable to prevent measurement errors caused by thermally-induced stresses. Moreover, the rigidity of manifolds 126, 128 and brace bars 132, 134 may actually exacerbate the problem of thermally-induced stresses. Further, applicable regulations may disallow flexible hoses or tubing from being used in certain applications, for example within a hydraulics compartment 88 of a fuel dispenser 34.

Embodiments of the present invention provide a Coriolis flow meter comprising a damper assembly for isolating a measurement section of the flow meter from these extraneous forces. According to one embodiment, the damper assembly comprises at least one damper element coupled between the measurement tube(s) of the flow meter and the body of the flow meter. The damper assembly may preferably located within, or internal to, the body of the flow meter. Thus, for example, in one application, a flow meter incorporating such a damper assembly may be installed in the hydraulics compartment 88 of a fuel dispenser 34.

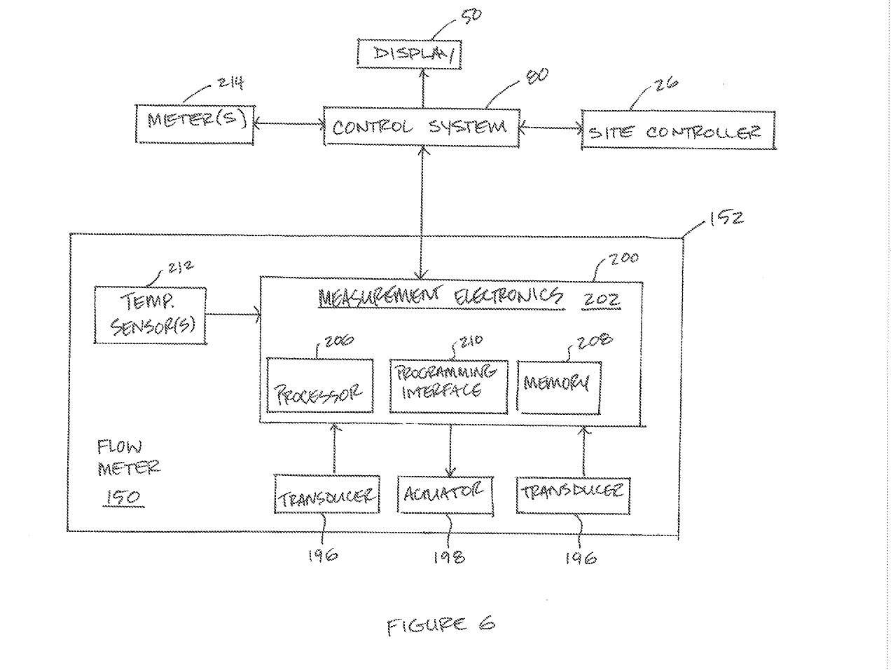

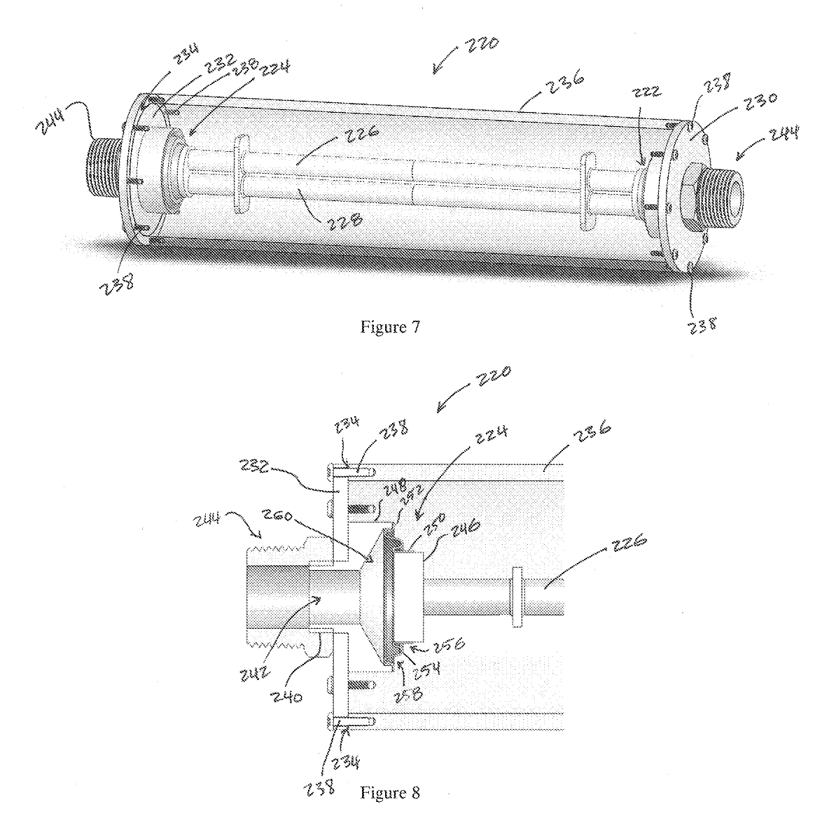

In this regard, FIG. 5 is a perspective view of a Coriolis flow meter 150, shown in partial cross section, comprising a damper assembly in accordance with one embodiment of the present invention. FIG. 6 is a block diagram illustrating internal electronics of flow meter 150 according to one embodiment of the present invention. FIGS. 7-9 are views of a Coriolis flow meter 220 in accordance with another embodiment of the present invention.

Turning first to FIG. 5, Coriolis flow meter 150, which in this embodiment may be a dual straight tube Coriolis flow meter, may comprise a body 152 which defines an upstream orifice 154 and a downstream orifice 156. Orifices 154 and 156 may be circular in shape and provide openings through which a process fluid to be measured may flow. Orifices 154 and 156 are preferably identical in this embodiment, and those of skill in the art will appreciate that the terms “upstream” and “downstream” are used only to distinguish the orifices based on the orientation in which flow meter 150 is installed in a conduit containing the process fluid.

More particularly, Coriolis flow meter 150 preferably defines a flow path 158 which extends between upstream orifice 154 and downstream orifice 156. Flow path 158 preferably comprises at least one measurement tube. In the illustrated embodiment, flow path 158 comprises dual measurement tubes 160, 162. Measurement tubes 160, 162, which are preferably substantially identical, may be circular in cross section and have centerlines which lie in parallel planes. In one preferred embodiment, measurement tubes 160, 162 may be formed of titanium. However, those of skill in the art are familiar with other suitable materials from which measurement tubes of a Coriolis flow meter may be formed, such as stainless steel. In any event, it will be appreciated that it is typically desired that measurement tubes 160, 162 be formed of a material having a lower coefficient of thermal expansion than that of body 152.

Body 152 may comprise a housing 164 and end plates 166, 168, in which orifices 154 and 156 are respectively defined. In this embodiment, housing 164 may extend the length of flow meter 150 between end plates 166, 168. Thus, housing 164 may fully surround measurement tubes 160, 162 in this embodiment. End plates 166, 168, which as shown are oriented perpendicularly to the centerlines of measurement tubes 160, 162, may have an outer diameter which is slightly less than the inner diameter of housing 164 such that end plates 166, 168 may be snugly received in either end of housing 164. Housing 164 may be respectively secured to end plates 166, 168 using suitable fasteners, such as screws 170. In this embodiment, housing 164 and end plates 166, 168 may be circular in cross section, though the particular shape is not required. In other embodiments, housing 164 and end plates 166, 168 may be square in cross section, for example. Housing 164 and end plates 166, 168 may be formed of a suitably strong, lightweight metal, such as steel or aluminum.

End plates 166, 168 are preferably configured to couple flow meter 150 with a conduit carrying fluid to be measured by flow meter 150. Although many specific configurations are possible, in the illustrated embodiment end plates 166, 168 may respectively define apertures 172 spaced about orifices 154, 156 by which end plates 166, 168 may be secured to a conduit. For example, apertures 172 may be sized and spaced such that a conduit may be secured to end plates 166, 168 using a suitable connector, such as the Parflange connector offered by Gilbarco Inc.

In this embodiment, flow path 158 further comprises an upstream manifold 174 and a downstream manifold 176 between which measurement tubes 160, 162 extend. Like end plates 166, 168, manifolds 174, 176 may be disposed in planes perpendicular to the planes in which the centerlines of measurement tubes 160, 162 lie. Upstream manifold 174 may divide fluid flow from the conduit evenly between measurement tubes 160, 162. Correspondingly, downstream manifold 176 may combine the fluid flow from measurement tubes 160, 162 into the downstream portion of the conduit.

Further, flow path 158 may comprise a damper assembly comprising at least one damper element configured to isolate measurement tubes 160, 162 from temperature effects and extraneous forces caused by various environments in which flow meter 150 may be used. As used in the present specification, the term damper element broadly refers to any dampening device which may be used to dampen extraneous vibrations, for example by absorbing and dissipating the energy therefrom. Moreover, in embodiments of the present invention, a damper element is preferably formed of a somewhat elastic material which restrains but allows axial motion (e.g., expansion and contraction) of measurement tubes 160, 162 caused by temperature effects. Thus, a damper element may be formed of a material having a stiffness that is substantially lower than the stiffness of measurement tubes 160, 162. As described in detail below, a damper element may take a variety of forms in accordance with embodiments of the present invention. In all cases, however, use of at least one damper element may reduce or eliminate both extraneous vibrations which may otherwise couple with the forces induced on measurement tubes 160, 162 during measurement and thermally-induced stresses which cause axial tension on and/or compression of measurement tubes 160, 162. It will be appreciated that the material from which a damper element is formed should be suitable for use in the presence of the fluid being measured. Thus, in some embodiments, damper elements may be formed of a material which is suitable for use in the presence of various types of fuel and in a fuel dispensing environment.

In this embodiment, flow path 158 comprises two damper elements 178, 180. Damper element 178 may be coupled between upstream manifold 174 and end plate 166. Damper element 180 may be coupled between downstream manifold 176 and end plate 168. In other embodiments, however, damper elements 178, 180 may not be directly coupled to end plates 166, 168. Also, in some embodiments, flow meter 150 may comprise only one damper element disposed between measurement tubes 160, 162 and body 152. In such a case, the end of measurement tubes 160, 162 not having a damper element may be directly coupled with a portion of body 152, such as one of end plates 166, 168.

As shown, damper elements 178, 180 may be generally frustoconical in shape, having a cross-sectional area which is generally circular but the diameter of which varies along its length. More particularly, damper elements 178, 180 may comprise an annular inner wall portion 182, the diameter of which is similar to the diameter of manifolds 174, 176, and an annular outer wall portion 184, the diameter of which is slightly larger than the diameter of inner wall portion 182. Outer wall portion 184, which may slightly overlap inner wall portion 182 in the direction of the longitudinal axis of damper elements 178, 180, may also be spaced apart from inner wall portion 182 by a groove 186. Accordingly, in this embodiment, damper elements 178, 180 may resemble a ripple or capillary wave. Additional views of embodiments of damper elements 178, 180 are provided in FIGS. 7-9 and discussed in more detail below. Of course, damper elements in accordance with the present invention are not limited to the shape of damper elements 178, 180, and as discussed below, many other configurations are contemplated.

Damper elements 178, 180 are preferably coupled between manifolds 174, 176 and end plates 166, 168, respectively. As shown in FIG. 5, in one embodiment, damper elements 178, 180 may be formed of molded nitrile butadiene rubber (NBR). End plates 166, 168 may define a neck portion 188 over which a skirt 190 of damper elements 178, 180 may be securely received. Similarly, annular inner wall portion 182 may be securely received over manifolds 174, 176. Suitable adhesive may be used to fix damper elements 178, 180 in place. In another embodiment, damper elements 178, 180 may be formed of thin stamped stainless steel which may be laser- or seam-welded in place with manifolds 174, 176 and end plates 166, 168.

Of course, many other elastic, dampening materials are appropriate for use in damper elements 178, 180. The material from which damper elements 178, 180 is formed may be selected based on the application for which flow meter 150 will be used, including the flow rates and fluid pressures of the fluid being measured. For example, in some high-pressure applications it may be desirable to select a slightly thicker material for damper elements 178, 180. Further, in fuel dispensing environment applications, it may be desirable to select a material having a slightly higher stiffness (though still less than that of measurement tubes 160, 162) to compensate for or reduce the impact of extraneous vibrations which could be caused by “nozzle snap.”

Although neck portion 188 is formed as a cylindrical extension of end plates 166, 168 in this embodiment, those of skill in the art will appreciate that, in other embodiments, end plates 166, 168 may have other configurations. For example, in some embodiments each end plate of a flow meter may define a separate neck portion for each measurement tube. In other embodiments, the end plates of a flow meter may define a flat interior surface, having no neck portion at all. In yet other embodiments, the end plates of a flow meter may define a convex or concave interior surface, with or without a neck portion.

Next, flow meter 150 may further comprise a pair of brace bars 192, each of which is coupled to measurement tubes 160, 162. Brace bars 192, which may be formed of the same or a different material as measurement tubes 160, 162, may comprise a substantially flat plate having two apertures 194 therein that is oriented perpendicularly to the centerlines of measurement tubes 160, 162. Measurement tubes 160, 162 may pass through the apertures 194, and brace bars 192, 194 may be welded thereto. Brace bars 192 may be spaced apart along measurement tubes 160, 162 at equal distances from manifolds 174, 176 respectively. As described above, brace bars 192 may further isolate the sections of tubes 160, 162 between brace bars 192 from extraneous forces by providing a pivot point for the motion of tubes 160, 162 under the forces induced thereon during measurement. It will be appreciated, however, that brace bars 192 are not required in all embodiments. In fact, it is contemplated that use of a damper assembly in accordance with the present invention may render brace bars 192 unnecessary in some applications.

Further, flow meter 150 may comprise a pair of transducers 196, each coupled between measurement tubes 160, 162. Transducers 196, which may be welded or brazed onto measurement tubes 160, 162 in some embodiments, are preferably analogous to transducers 138, 140 described above. Thus, transducers 196 may be each disposed an equal lateral distance from brace bars 194. Flow meter 150 may also comprise an actuator 198 coupled between measurement tubes 160, 162. Actuator 198 is preferably analogous to actuator 136 described above and thus is configured to excite measurement tubes 160, 162 in a predetermined mode of vibration. In the embodiment shown in FIG. 5, actuator 198 is disposed on the side of measurement tubes 160, 162 opposite transducers 196 and thus is only partially visible. Transducers 196 may measure either the velocity or displacement of measurement tubes 160, 162 when measurement tubes 160, 162 are excited by actuator 198.

In prior art Coriolis flow meters, some or all of the measurement electronics are located outside of the flow meter housing. For example, the programming interface for the flow meter is typically located in a separate, outer housing. According to embodiments of the present invention however, the measurement electronics, including the programming interface, are preferably located internal to the flow meter housing.

As shown in FIG. 5, flow meter 150 may comprise a substrate 200, which in some embodiments may be a printed circuit board, on which measurement electronics 202 (FIG. 6) are provided. Substrate 200 may preferably be annular in shape and oriented perpendicularly to the centerlines of measurement tubes 160, 162. Substrate 200 may define an aperture 204 through which measurement tubes 160, 162 extend, such that substrate 200 surrounds measurement tubes 160, 162. Further, substrate 200 may preferably be positioned proximate either end of measurement tubes 160, 162, upstream or downstream of the section of measurement tubes 160, 162 in which fluid is measured. In this embodiment, substrate 200 is disposed at the upstream end of measurement tubes 160, 162 proximate manifold 174. Substrate 200 may be secured at this position, such as by suitable fasteners 206 coupled with end plate 166. Although substrate 200 is annular in this embodiment, in other embodiments discussed below substrate 200 may be rectangular in shape and extend axially inside of housing 164.

Measurement electronics 202 are described in further detail with reference to FIG. 6. Measurement electronics 202 may preferably comprise a processor 206 and a memory 208. Processor 206 may be any suitable commercially available processor or other logic machine capable of executing instructions, such as a general-purpose microprocessor or a digital signal processor (DSP). Additionally, more than one processor may be provided. Processor 206 may be readily programmable; hard-wired, such as an application specific integrated circuit (ASIC); or programmable under special circumstances, such as a programmable logic array (PLA) or field programmable gate array (FPGA), for example. Program memory for the processor 206 may be integrated within the processor 206, may be part of memory 208, or may be an external memory. Memory 208 may be any suitable memory or computer-readable medium as long as it is capable of being accessed by the control system, including RAM, ROM, EPROM, or EEPROM, CD-ROM, DVD, or other optical disk storage, SSD, magnetic disc storage, including floppy or hard drives, any type of suitable non-volatile memories, such as SD, flash memory, memory stick, or any other medium that may be used to carry or store computer program code in the form of computer-executable programs, instructions, or data.

Processor 206 may execute one or more programs to control the operation of the other components, to transfer data between the other components, to associate data from the various components together (preferably in a suitable data structure), to perform calculations using the data, to otherwise manipulate the data, and to transmit results for other uses and for display to a user. For example, processor 206 may be in electronic communication with an external control system, such as control system 80 of fuel dispenser 34. In this regard, processor 206 may execute an algorithm which determines the mass flow rate, density, temperature, and/or volumetric flow rate of fluid being measured and transmits this information to control system 80. Control system 80 may use this information to display a volume and price of fuel dispensed to a user on display 50. It is preferred that communications between control system 80 and processor 206 be encrypted using suitable encryption algorithms known to those of skill in the art.

Measurement electronics 202 may further comprise a programming interface 210 which may be configured to receive user input from a variety of wired or wireless input devices and may also support various wired, wireless, optical, and other communication standards. According to one embodiment, programming interface 210 comprises a universal interface driver application specific integrated circuit (UIDA). Further details of the UIDA can be found in U.S. Pat. No. 6,877,663, which is hereby incorporated by reference in its entirety for all purposes. Further, programming interface 210 may include one or more data interfaces, bus interfaces, wired or wireless network adapters, or modems for transmitting and receiving data. Accordingly, programming interface 210 may include one or more of hardware, software, and firmware to implement one or more protocols, such as stacked protocols along with corresponding layers. Thus, programming interface 210 may function as one or more of a serial port (e.g., RS232), a Universal Serial Bus (USB) port, and an IR interface.

Measurement electronics 202 may be in electrical communication with transducers 196 and actuator 198. Further, measurement electronics 202 may be in electrical communication with one or more temperature sensors 212 of flow meter 150. Those of ordinary skill in the art are familiar with the use of temperature sensors in Coriolis flow meters, and thus temperature sensors 212 are not illustrated in FIG. 5. In general, however, flow meter 150 may comprise at least one temperature sensor 212 positioned so that it measures the temperature of measurement tubes 160, 162 and outputs to measurement electronics 202 a signal representative thereof. Because it may not be desirable to couple the temperature sensor 212 directly with measurement tubes 160, 162, the temperature sensor 212 may be coupled with one of end plates 166, 168 (for example, within a recess therein) and positioned at a point proximate the fluid to be measured. The temperature of the fluid being measured will be substantially the same as the temperature of measurement tubes 160, 162. In other embodiments, however, the temperature sensor 212 could also be positioned within one of manifolds 174, 176 and in contact with the flowing fluid. Signals from this temperature sensor 212 provided to measurement electronics 202 may be used by measurement electronics 202 to determine the volumetric flow rate of the fluid to be measured. Temperature sensor 212 may be provided because the volume of a fluid is temperature dependent, and thus measurement electronics may not be able to accurately determine the volumetric flow rate by simply dividing the mass flow rate of the fluid by the fluid density. Additional information regarding automatic temperature compensation in fuel dispensers is provided in U.S. Pat. No. 5,557,084, the entire disclosure of which is incorporated by reference herein for all purposes.

In addition to using temperature sensors to determine volumetric flow rate, temperature sensors may be used to correct for temperature-induced errors in the measured mass flow rate. More particularly, as described above, such errors may be caused by axial tension and compression of the measurement tubes. Some prior art systems attempted to correct for these errors by measuring both the temperature of an element of the flow meter body and the temperature of the measurement tubes themselves. Suitable electronics receiving signals from both temperature sensors would determine a correction factor to be applied to the calculated mass flow rate to compensate for the temperature-induced errors. One example of such a prior art flow meter is disclosed in U.S. Pat. No. 4,768,384, the entirety of which is incorporated by reference herein for all purposes.

As noted above, by using a damper assembly in embodiments of the invention, thermally-induced stresses on measurement tubes 160, 162 may be reduced. However, it may not be possible to avoid these stresses altogether, particularly where the damper assembly comprises only a single damper element 178 or 180. Similarly, it may not be possible to avoid thermally-induced stresses in applications involving temperature extremes. For example, in many applications, embodiments of the flow meter of the present invention may be used to measure fluids at temperatures between approximately −40° F. to 140° F. However, in other applications, embodiments of the flow meter of the present invention may be used for the measurement of LNG, which may occur at temperatures of approximately −195° F. to −250° F. Thus, some embodiments of the invention may likewise determine a correction factor for any temperature-induced errors. For example, flow meter 150 may comprise another temperature sensor 212 to determine the temperature of a portion of body 152 and output a signal representative thereof to measurement electronics 202. Where such a temperature sensor 212 is provided, it may determine the temperature of one of end plates 166, 168 or housing 164. Thereby, in conjunction with the signals representative of the temperature of measurement tubes 160, 162, measurement electronics may calculate a correction factor for any temperature-induced errors on the calculation of the mass flow rate. Temperature sensors 212 may be resistance temperature detectors in one embodiment, but those of skill in the art are familiar with other suitable sensors for temperature sensors 212.

In operation of one embodiment of flow meter 150 in a fuel dispensing environment, fuel may flow from a conduit (such as internal fuel piping 74) into orifice 154 defined in end plate 166. Next, fluid flows through damper element 178 into manifold 174, where it may be divided evenly between measurement tubes 160, 162. Measurement electronics may cause actuator 198 to vibrate measurement tubes 160, 162 in a predetermined mode of vibration, and transducers 196 may sense the mechanical vibrations of measurement tubes 160, 162 and output electrical signals representative thereof to measurement electronics 202. Fluid may then flow into manifold 176, where it may be combined and then flow through damper element 180. Finally, fluid may exit flow meter 150 through orifice 156 defined in end plate 168 and reenter internal fuel piping 74.

Based on the time or phase delay between the signals output by transducers 196 (caused by inertial forces acting on measurement tubes 160, 162), measurement electronics 202 may calculate the mass flow rate of the flowing fluid. Measurement electronics 202 may further calculate the density of the fluid, as is well known. Based on signals from temperature sensors 212, measurement electronics 202 may also determine the temperature of the fluid, which measurement electronics 202 may use, along with the fluid density, to determine the volumetric flow rate of the fluid. Further, if provided, measurement electronics 202 may use signals from additional temperature sensor(s) 212 representative of the temperature of a portion of body 152 to calculate a correction factor for any temperature-induced measurement errors. Measurement electronics 202 may output signals representative of the volumetric flow rate to control system 80, which may use this information to display a volume and price of fuel dispensed to a user on display 50.

According to another embodiment of the present invention, where flow meter 150 is used in a fuel dispensing environment, some or all of the functions of measurement electronics 202 described above may be performed at a remote control system, such as control system 80 or site controller 26. Thus, in some embodiments, a given flow meter 150 and/or 220 may comprise only a portion of measurement electronics 202 or no measurement electronics 202 at all. For example, control system 80 may be in electrical communication with transducers 196, actuator 198, and temperature sensor(s) 212 so that control system 80 may calculate the mass flow rate, density, temperature, and volumetric flow rate of the measured fluid. Likewise, control system 80 may also comprise programming interface 210 for flow meter 150. In fact, as shown in FIG. 6, control system 80 may handle some or all of the measurement electronics processing for flow meter 150 and one or more other meters 220. Moreover, in some embodiments, information gathered by measurement electronics 202 may be monitored remotely via site controller 26.

In embodiments of the present invention, it is contemplated that flow meter 150 may be calibrated initially, such as during or following manufacture, and be configured to calibrate itself while implemented in a flow measurement application. First, for example, after manufacture, flow meter 150 may be calibrated to obtain the correction factor described above for temperature-induced measurement errors. In addition, this correction factor may take into account given frequencies of vibration, such as resonant frequencies of vibration, in some embodiments. Further, in some embodiments, a gain factor correction factor may be developed for each flow meter 150 by performing calibration measurements with a nominal fluid at a nominal temperature at several varying flow rates. The correction factor may be in the form of an algorithm, lookup table, polynomial curve, or formula or the like. In addition or in the alternative, it is contemplated that a correction factor may be obtained by measuring a meter after manufacture to compare details of the manufactured meter to an “ideal” or “theoretical” meter. This may be accomplished, for example, by 3D scanning or by physical measurement of certain components of the flow meter.

Also, after it has been installed in a flow measurement application, flow meter 150 may preferably be configured to periodically “zero” itself. More particularly, those of skill in the art are familiar with “calibration drift,” or the process by which the accuracy of a flow meter which has been calibrated at manufacture “drifts,” or decreases, over time due to various factors. Calibration drift may be due to the environment in which the flow meter operates or due to wear or aging of certain parts of the flow meter. In any event, flow meter 150 is preferably configured to obtain information from transducers 196 at times when fluid is not being measured in order to obtain a “baseline” reading. This may be particularly appropriate where the fluid being measured has parameters which may vary somewhat from measurement to measurement.

For example, in an embodiment where flow meter 150 is used in a fuel dispensing environment, control system 80 may have received a flow switch communication signal from flow switch 96 indicating that fuel is not flowing and that a transaction is not ongoing. At that point, control system 80 may instruct processor 206 of measurement electronics 202 to obtain information regarding the phase offset, if any, from transducers 196 when fluid is not being measured. Measurement electronics 202 may store this information as a baseline against which readings for subsequent transactions may be compared. It will be appreciated that this may increase the accuracy of measurement during fluid flow.

Moreover, information from transducers 196 during a period in which flow switch 96 indicates that fuel is not flowing may be used to detect fraud or fuel dispenser malfunction. In particular, if the information from transducers 196 indicates that fuel is flowing, contrary to information from flow switch 96, control system 80 may take any appropriate action to prevent fraud or malfunction, such as signaling an alarm condition to site controller 26, closing other valves, or instructing STP 56 to stop pumping fuel.

In another embodiment, control system 80 or measurement electronics 202, or both, may use information from various sensors of flow meter 150 to detect a change in volume concentration during fluid measurement, which may occur in fuel dispensers having integral pumps, for example. In this regard, applicable weights and measures air separation requirements for fuel dispensing applications may require that no more than 20% air be present in fuel. Additionally, introducing air into fuel is one technique used by fraudsters to misrepresent the amount of fuel dispensed. Thus, in an application where flow meter 150 is used in a fuel dispensing environment, information from transducers 196 or temperature sensor(s) 212 may be used to identify air in the fuel outside of required tolerances. For example, control system 80 or measurement electronics 202 may identify a predetermined change in fluid density, such as a change in density outside of a predetermined range or band of acceptable densities, as being due to air present in the fuel being dispensed. Where air outside of required tolerances is detected, control system 80 may again take any appropriate action to prevent fraud or malfunction. Notably, this may reduce or eliminate the need for certain components, such as filters and sumps, currently required to remove air from fuel during dispensing.

Further, also during periods of no fluid flow, processor 206 may perform modal testing of measurement tubes 160, 162 to determine the modal frequencies of vibration thereof. Those of ordinary skill in the art are familiar with modal testing, and thus it is not described in detail here. In general, however, processor 206 may cause actuator 198 to vibrate measurement tubes 160, 162 at known frequencies and obtain information from transducers 196 regarding the amplitude or displacement of measurement tubes 160, 162. Where structural resonances occur, processor 206 may detect an amplification of the response from transducers 196. Thereby, processor 206 may develop a transfer function describing the relationship between the input forces and the output response of measurement tubes 160, 162. This information may be useful in improving the accuracy of flow measurement because the modal frequencies of measurement tubes 160, 162 may differ between initial calibration, installation in a given flow measurement application, and due to changes in the environment of the flow measurement application over time. The modal frequencies of measurement tubes 160, 162 may also differ with temperature, pressure, velocity of sound, flow rate, and other parameters.

Additional embodiments of Coriolis flow meters comprising embodiments of a damper assembly in accordance with the present invention are discussed with reference to FIGS. 7-22. Because many details of a Coriolis flow meter have been explained fully above, these details are not discussed with respect to these embodiments. Also, although some elements discussed above, such as the transducers and actuators, are not shown in each of the remaining figures, those of skill in the art will appreciate that the flow meter embodiments discussed may include such elements. Further, the embodiments discussed below may be used with any of the embodiments of measurement electronics 202 discussed above. Alternatively, the flow meter embodiments discussed below may not include measurement electronics 202 and may operate in conjunction with a suitable external control system, such as control system 80, also as discussed above.

FIGS. 7-9 are views of a Coriolis flow meter 220 comprising a damper assembly in accordance with another embodiment of the present invention. Flow meter 220 may be similar to flow meter 150 in many respects, and thus flow meter 220 may comprise damper elements 222, 224 coupled between measurement tubes 226, 228 and end plates 230, 232. In this embodiment, however, end plates 230, 232 of flow meter 220 differ from end plates 166, 168 described above. For example, end plates 230, 232 may be coupled with end faces 234 of a housing 236 of flow meter 220 using a plurality of fasteners 238.

End plates 230, 232 are preferably configured to couple flow meter 220 with a conduit carrying fluid to be measured by flow meter 220. The embodiment shown in FIGS. 7-8 has a different configuration than the embodiment shown in FIG. 5. In particular, end plates 230, 232 of flow meter 220 may respectively define a threaded stem 240 having an orifice 242 defined therein (FIG. 8). A threaded coupling 244 may be screwed or fastened on stem 240. Thereby, sections of a conduit may be coupled with flow meter 220 via coupling 244.

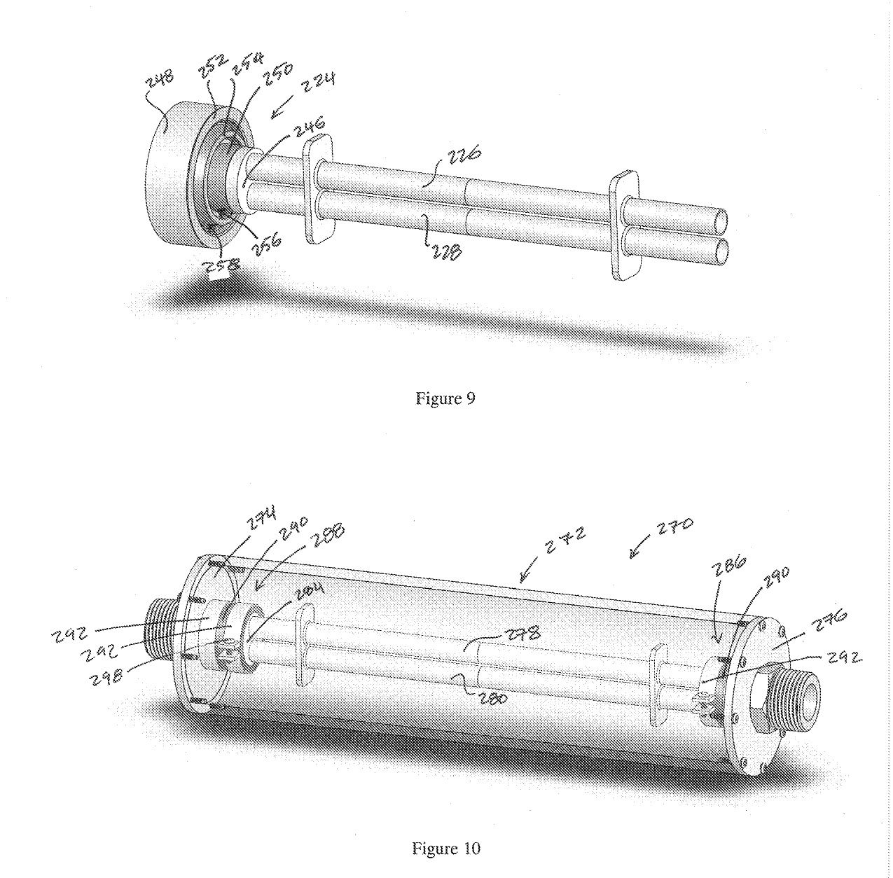

As shown in FIG. 8, which is a partial cross section of damper element 224 of flow meter 220, and in FIG. 9, which is an enlarged perspective view of damper element 224 and measurement tubes 226, 228, damper elements 222, 224 are preferably analogous to damper elements 178, 180, described above. In this embodiment, damper element 224 may be coupled between a downstream manifold 246 and a neck portion 248 of end plate 232. As with damper elements 178, 180, damper elements 222, 224 may comprise an annular inner wall portion 250. Here, though, damper elements 222, 224 may comprise an outer annular lip 252 by which they are coupled with neck portions 248 of end plates 230, 232, rather than an annular outer wall portion. In this embodiment, damper elements 222, 224 may comprise an annular ridge 254 spaced apart from inner annular wall portions 250 and outer annular lips 252 by grooves 256, 258. Annular ridge 254 may slightly overlap inner wall portion 250 in the direction of the longitudinal axis of damper elements 222, 224. Accordingly, in this embodiment, damper elements 222, 224 may also resemble a ripple or capillary wave.

Finally, as shown, end plate 232 may preferably define a flow guide 260 in neck portion 248. Flow guide 260, which is in fluid communication with orifice 242, may preferably define a larger diameter at its upstream end and a smaller diameter substantially equal to the diameter of orifice 242 at its downstream end. End plate 230 may define a similar flow guide 260, but which has a larger diameter at its downstream end and a smaller diameter equal to the diameter of the orifice in end plate 230 at its upstream end. It will be appreciated that flow guide 260 may reduce the pressure drop which occurs as fluid flows between a conduit and measurement tubes 226, 228.

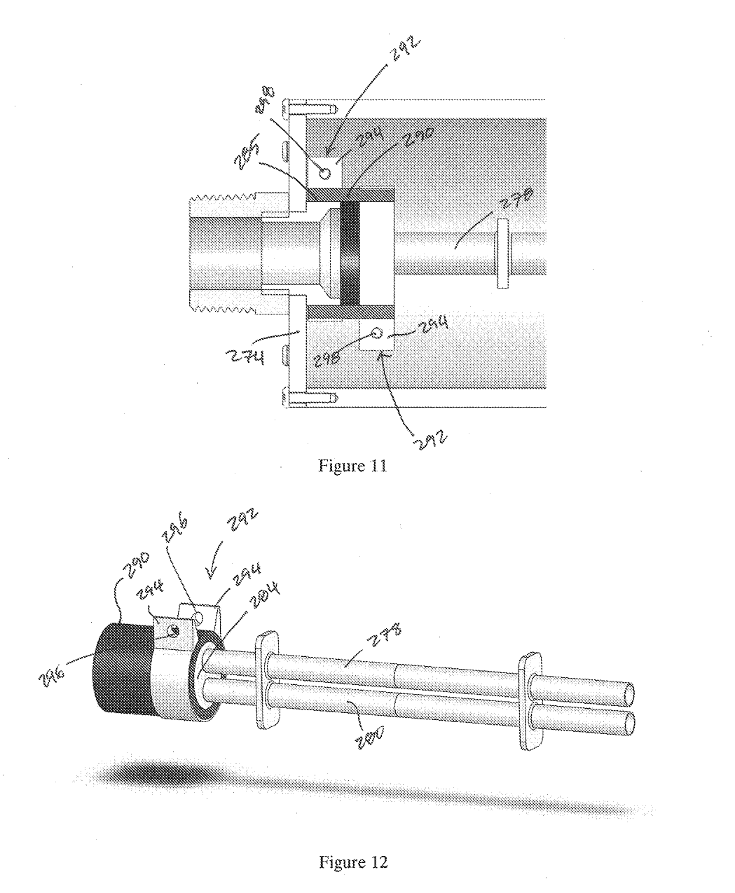

A further embodiment of the present invention is described with reference to FIGS. 10-12. In particular, FIG. 10 is a perspective view of a Coriolis flow meter 270, shown in partial cross section, comprising a damper assembly in accordance with another embodiment of the present invention. FIG. 11 is a partial cross section of the damper assembly of Coriolis flow meter 270, and FIG. 12 is an enlarged perspective view of the damper assembly and measurement tubes of Coriolis flow meter 270. As shown, it will be appreciated that Coriolis flow meter 270 may be similar in many respects to Coriolis flow meters 150 and 220, described above. To simplify description of this embodiment, then, certain details regarding the construction and operation of flow meter 270 which would be apparent to those of skill in the art upon reading the above disclosure are omitted below.

In this regard, flow meter 270 may comprise a body 272 comprising laterally opposing end plates 274, 276. Meter 270 may further comprise parallel measurement tubes 278, 280, the centerlines of which may be perpendicular to end plates 274, 276. Measurement tubes 278, 280 may extend between an upstream manifold 282 (not visible in FIG. 10) and a downstream manifold 284. Further, end plates 274, 276 may preferably define a cylindrical neck portion 285 (FIG. 11).

As shown in more detail in FIGS. 11-12, flow meter 270 may also comprise a damper assembly comprising two damper elements 286, 288. In this embodiment, damper elements 286, 288 may comprise a hose member 290. Hose member 290, which may preferably be cylindrical in shape, may define an inside diameter slightly larger than that of manifolds 282, 284. Thereby, hose member 290 may be snugly received over each manifold 282, 284. Further, in this embodiment neck portion 285 may preferably have a diameter substantially equal to the diameter of manifolds 282, 284. Thus, hose member 290 may also be snugly received over neck portion 285. Notably, hose member 290 need not have a uniform diameter along its length in all embodiments.

A variety of configurations may be used to secure damper elements 286, 288 in place over manifolds 282, 284 and neck portions 285. In one embodiment, for example, damper elements 286, 288 may be secured in place using suitable adhesive. According to further embodiments, manifolds 282, 284 and neck portion 285 may also define engagement features, such as raised ridges, which may further secure hose members 290 in place.

In the illustrated embodiment, on the other hand, two metal bands 292 may be used. Metal bands 292 may be formed of stainless steel, though other metals may also be used. As shown in FIG. 12, which illustrates a metal band 292 in a relaxed, unsecured position, metal bands 292 may comprise a length of flat metal having a width that is slightly less than half of the length of hose members 290. At either end of the length of metal is provided a tine 294 which extends upward in a direction generally perpendicular to the metal band. Each tine 294 may define a threaded aperture 296 therethrough. The metal of bands 292 may be bent such that it forms a cylindrical shape when a suitable fastener 298 is secured in both apertures 296 of tines 294. Preferably, the length of bands 292 is selected such that, when a band 292 is provided over hose member 290 and a fastener 298 is inserted in both apertures 296 of tines 294, the internal diameter of the cylindrical shape formed by band 292 is slightly larger than that of hose member 290. As fastener 298 is tightened, tines 294 move closer together, decreasing the internal diameter of the cylinder. Thus, bands 292 may be tightened to secure hose member 290 in place.

Moreover, damper elements 286, 288 comprising hose member 290 may not be secured over manifolds 282, 284 and neck portions 285 in all embodiments. Rather, in some embodiments, damper elements 286, 288 may comprise a hose member which is disposed within the flow path internal to end plates 274, 276. For example, measurement tubes 278, 280 may extend into one or more corresponding apertures defining the entrance to the flow path within each of end plates 274, 276. However, rather than measurement tubes 278, 280 being in direct contact with end plates 274, 276, damper elements 286, 288 may separate measurement tubes 278, 280 from end plates 274, 276. In one such embodiment, a hose member of damper elements 286, 288 may be formed such that its exterior dimensions correspond to or are slightly smaller than the interior dimensions of the flow path of end plates 274, 276 along the length thereof. Therefore, during assembly, damper elements 286, 288 may be installed within the flow path, for example using suitable adhesive.

Hose members 290 may preferably be formed of an elastic material, such as fluorosilicone rubber, neoprene rubber, NBR, or Viton®, offered by Dupont Performance Elastomers, LLC. In other embodiments hose member 290 may also be formed of a suitable plastic material. As explained above, it is preferred that hose members 290 be somewhat compliant, having a stiffness less than that of measurement tubes 278, 280. In one embodiment, hose member 290 may be formed of a material having a burst pressure of between 250 and 323 psi. Those of skill in the art will appreciate that the thickness of the material selected for hose members 290 may depend on the pressures at which fluids will flow through meter 270. In addition, because the stiffness of hose members 290 may change with temperature, it is desirable that embodiments of flow meter 270 comprise measurement electronics capable of periodically recalibrating meter 270, for example by performing modal frequency testing or by measuring the phase offset at times during which fluid is not flowing, as described above.

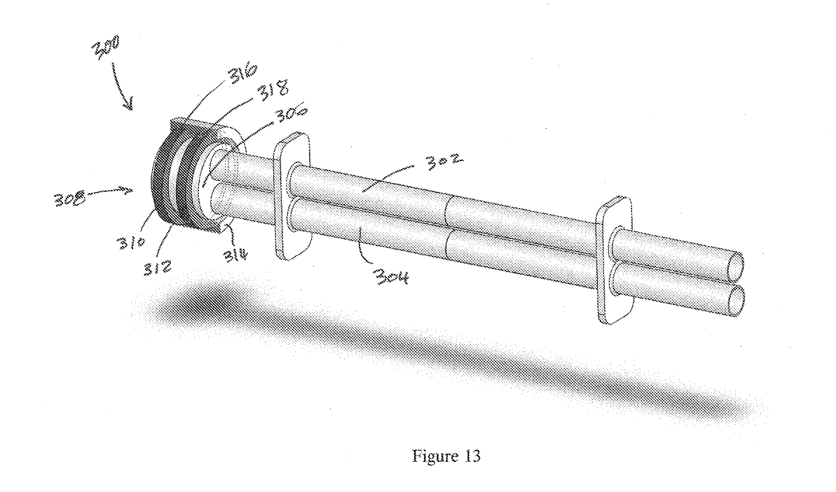

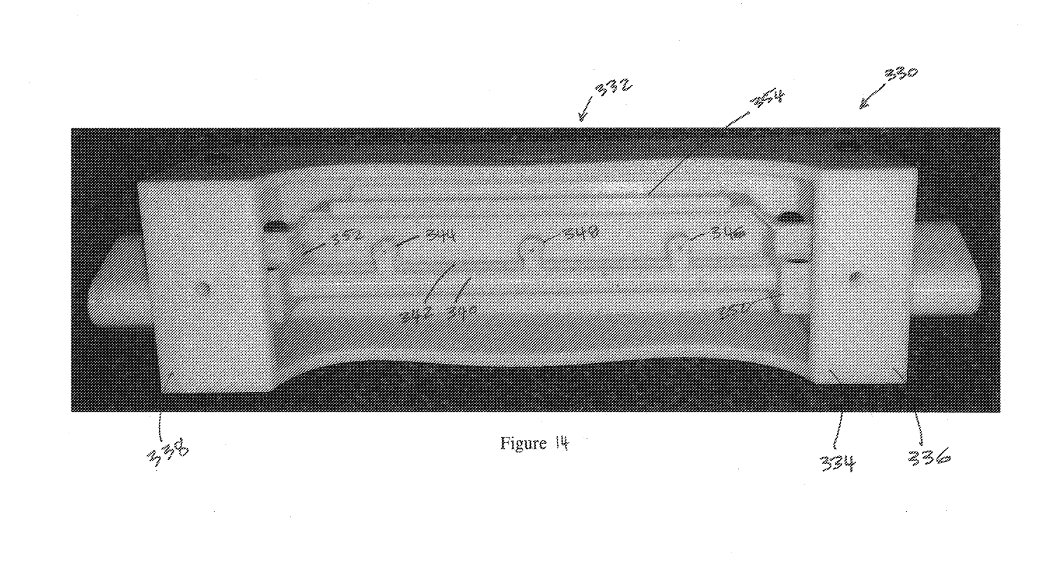

According to a further embodiment of the present invention, a damper assembly may comprise one or more damper elements comprising at least one O-ring. In this regard, FIG. 13 is an enlarged perspective view of a damper assembly 300 and measurement tubes 302, 304 of a Coriolis flow meter. As described above, measurement tubes 302, 304 may extend between an upstream manifold (not shown) and a downstream manifold 306. In this embodiment, damper assembly 300 comprises a damper element 308. Damper element 308 may comprise two O-rings 310, 312 coupled over and spaced apart along the length of manifold 306. Although two O-rings 310, 312 are shown in this embodiment, other embodiments may comprise a single O-ring or three or more O-rings, as needed or desired for a particular application.

The Coriolis flow meter comprising damper element 308 may comprise a neck portion 314 (shown in partial cross-section) defined on one of its end plates. In FIG. 13, O-rings 310, 312 may be sized such that they may be received in grooves 316, 318 formed in neck portion 314. Further, although O-rings 310, 312 may have a square cross-sectional area, O-rings 310, 312 may have cross-sectional areas of circular or other shapes in other embodiments. Thus, O-rings 310, 312 may form a fluid-tight seal in the end plate of the Coriolis flow meter which also isolates measurement tubes 302, 304 from extraneous vibrations and temperature effects. Those of skill in the art may select a material for o-rings 310, 312 suitable for the environment in which the flow meter may be used and for the fluid to be measured. O-rings 310, 312 may be formed of a suitable rubber material or a synthetic rubber such as neoprene or Viton®.

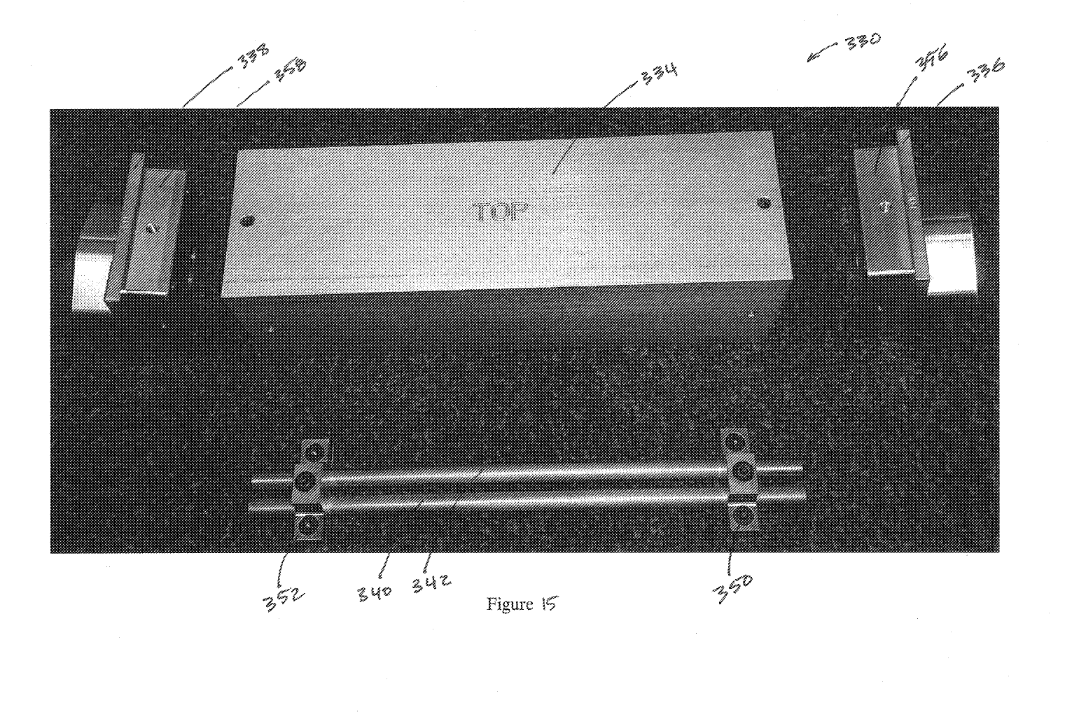

FIGS. 14-17 are views of prototypes of a Coriolis flow meter constructed in accordance with an embodiment of the present invention and comprising a damper assembly similar to that described above with respect to FIG. 13. In this regard, FIG. 14 is a partial cutaway view of a Coriolis flow meter 330. In this embodiment, flow meter 330 may define a body 332 that is square in cross section, which comprises a housing 334 and end plates 336, 338. Here, flow meter 330 also comprises a flow path comprising measurement tubes 340, 342. Transducers 344, 346 and an actuator 348 may be coupled with measurement tubes 340, 342 as described above.

Notably, flow meter 330 of this embodiment comprises a rectangular platform on which measurement electronics may be provided. More particularly, flow meter 330 may comprise brace bars 350, 352, each coupled with measurement tubes 340, 342 and spaced an equal distance from a respective one of end plates 336, 338. A platform 354, which may comprise a substrate on which measurement electronics are provided, may preferably be coupled between brace bars 350, 352. Platform 354 preferably extends parallel with but spaced apart from the centerlines of measurement tubes 340, 342 along the interior of housing 334. Platform 354 may define a length suitable for the provision of measurement electronics for flow meter 330.

FIG. 15 is a partial exploded view of Coriolis flow meter 330. Notably, measurement tubes 340, 342 are not directly coupled with manifolds in this embodiment. Rather, as shown, end plates 336, 338 may respectively comprise an upstream manifold 356 and a downstream manifold 358. Platform 354 is not shown in FIG. 15.

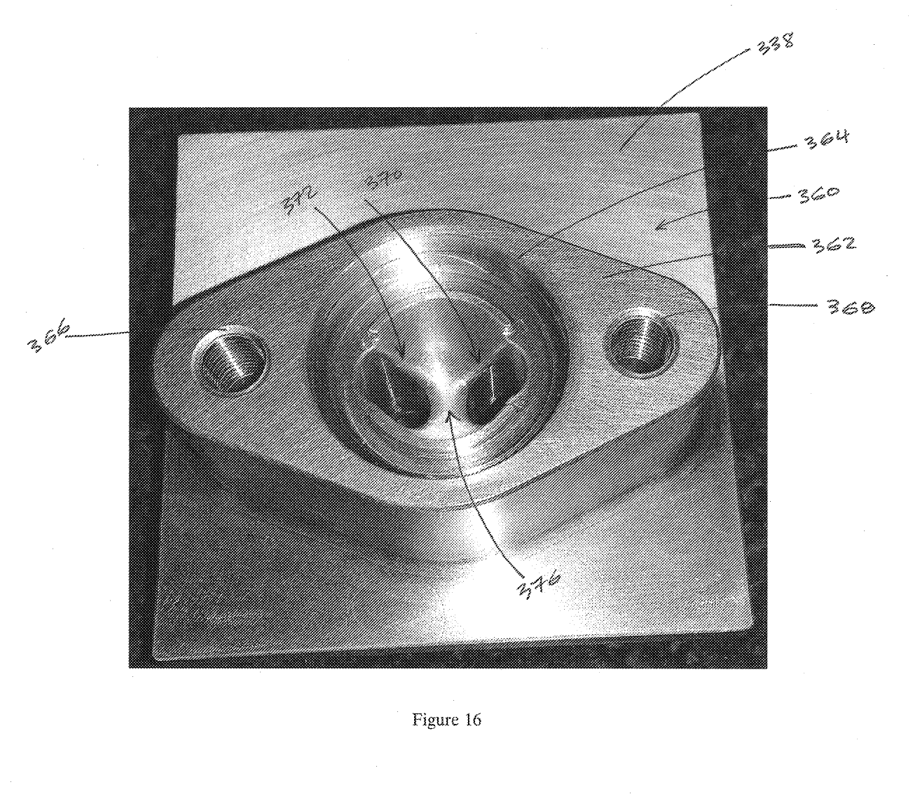

FIG. 16 is an enlarged view of an outer face 360 of end plate 338 of flow meter 330. End plate 338, which may be identical in construction to end plate 336, preferably defines a coupling 362 extending perpendicularly therefrom by which end plate 338 may be coupled with the downstream portion of a conduit. Coupling 362 may be diamond-shaped in this embodiment, though this is not required in other embodiments. Coupling 362, in which an orifice 364 may be defined, may also define threaded apertures 366, 368 configured to receive a suitable connector, such as the Parflange connector mentioned above.

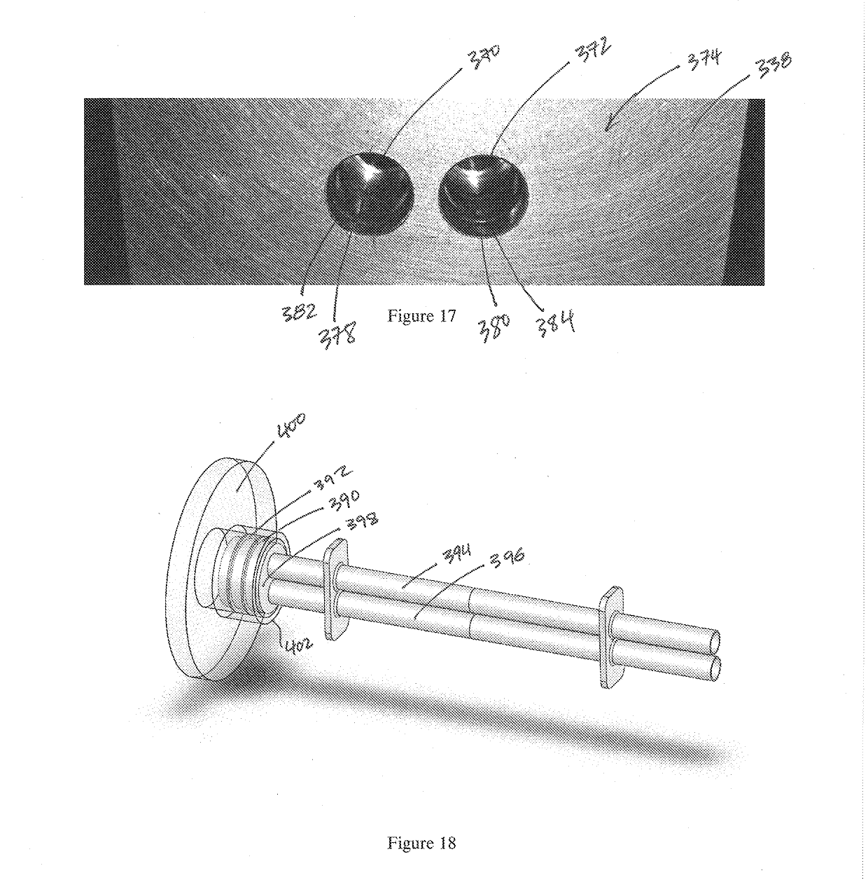

The interior of manifold 358 is partially visible in FIGS. 16 and 17. FIG. 17 is an enlarged view of an inner face 374 of end plate 338. In particular, manifold 358 may comprise flow tubes 370, 372, each of which may preferably be concentric with and slightly larger in diameter than a respective one of measurement tubes 340, 342. As shown in FIG. 16, manifold 358 may also comprise a flow guide 376, downstream of which the flow of fluid from measurement tubes 340, 342 combines in orifice 364.

As noted above, in this embodiment flow meter 330 comprises a damper assembly similar to that described with reference to FIG. 13. Here, the damper assembly may comprise damper elements in the form of upstream O-rings 378, 380 and downstream O-rings 382, 384 respectively provided in flow tubes 370, 372. O-rings 378, 380, 382, 384 may be received in grooves defined in manifold 358. The damper assembly may comprise analogous damper elements in end cap 336.

When flow meter 330 is assembled, measurement tubes 340, 342 may be inserted in flow tubes 370, 372 in end plate 338 and in analogous flow tubes defined in end plate 336. Because of the damper assembly, however, the upstream and downstream ends of measurement tubes 340, 342 may be free (or “floating”) with respect to each end plate 336, 338. In other words, the damper assembly of this embodiment may restrain axial motion of measurement tubes 340, 340 but allow axial expansion and contraction thereof. This may reduce or eliminate temperature-induced measurement errors in flow meter 330. Likewise, the damper assembly may reduce or eliminate the influence of extraneous vibrations on measurement tubes 340, 342. As noted above, however, in some embodiments damper elements 378, 380, 382, 384 may be provided only in end plate 338, and measurement tubes 340, 342 may be directly coupled with end plate 336 (or vice versa).

Additionally, in some embodiments, a damper assembly may comprise features of multiple damper elements described above. For example, a damper assembly may comprise damper elements in the form of both a hose member and O-rings. In one embodiment, the hose member may define flow tubes sized to receive the measurement tubes of a flow meter, and the flow tubes may further have O-rings provided therein. Alternatively, a damper assembly may have different damper elements described above at each of the upstream and downstream ends of the measurement tubes. Those of skill in the art will appreciate that many other configurations are possible within the scope of the present invention.

Turning now to FIG. 18, a damper assembly may also comprise damper elements in the form of piston rings 390, 392. More particularly, a Coriolis flow meter may comprise measurement tubes 394, 396 coupled with a downstream manifold 398. Further, the flow meter may comprise an end plate 400 (only partially shown in FIG. 18) which defines a neck portion 402. Piston rings 390, 392 may be disposed between manifold 398 and neck portion 402. Again, although two piston rings 390, 392 are illustrated in FIG. 18, it will be appreciated that a single piston ring or more than two piston rings may be provided in other embodiments.

Piston rings 390, 392, which may be formed of stainless steel or another suitable wear-resistant material, may be annular in shape and may be split (or define a gap) at one angular location around the circumference thereof. In one embodiment, piston rings 390, 392 may have a square or rectangular cross-sectional area, though in other embodiments piston rings 390, 392 may have a differently-shaped cross-sectional area, such as trapezoidal. Piston rings 390, 392 may be fixed in corresponding grooves or slots with respect to one of neck portion 402 and manifold 398. It will be appreciated that this may provide a reduced friction interface between neck portion 402, measurement tubes 394, 396, and manifold 398. This may facilitate axial expansion and contraction of measurement tubes 394, 396.

Flow meters constructed in accordance with embodiments of the present invention may also be used in hazardous areas in certain applications. Where this is the case, a given flow meter may further comprise an intrinsically safe, explosion proof, or flameproof housing, which may be incorporated into the flow meter body or further surrounding the flow meter. In an embodiment comprising an intrinsically safe housing, the flow meter may be powered via an intrinsically safe power supply and comprise a safety barrier. In other embodiments, a flow meter in accordance with the present invention may be further installed in a safety-approved, explosion proof box. Those of ordinary skill in the art are familiar with intrinsically safe, explosion proof, and flameproof techniques. Notably, however, because the flow meter damper assembly may be located internal to the flow meter in embodiments of the present invention, the use of such housings may not interfere with the ability of the damper assembly to isolate the measurement tubes from external vibrations and temperature effects. Where the flow meter is not located in a hazardous location, however, it will be appreciated that such housings are not necessary.

It can thus be seen that embodiments of the present invention provide a novel Coriolis flow meter and damper assemblies for use in Coriolis flow meters. Embodiments of the present invention may provide damper assemblies which isolate the measurement tube(s) of a Coriolis flow meter from extraneous vibrations and allow the measurement tubes to expand and contract in response to changes in temperature. Thus, use of a damper assembly in accordance with the present invention may reduce measurement error caused by extraneous vibrations and temperature effects. Moreover, use of a damper assembly in accordance with embodiments of the invention may reduce the cost and complexity of manufacture, in that the structures supporting the measurement tube(s) of the flow meter may not need to be made extremely rigid and heavy, as in prior art meters.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A Coriolis flow meter for measuring characteristics of a fluid flowing in a conduit, said flow meter comprising:
a first end structure and a second end structure;
a flow path extending between said first end structure and said second end structure, said first and second end structures connectable with said conduit such that said fluid flowing in said conduit enters said flow meter at one of said first and second end structures, travels along said flow path, and exits said flow meter at the other of said first and second end structures;
said flow path comprising at least one measurement tube having a first end and a second end;
said flow path further comprising a damper assembly comprising at least one damper element, said at least one damper element disposed between said first end structure and said at least one measurement tube first end such that said at least one measurement tube is not fixed with respect to said first end structure; and
at least one transducer coupled with said at least one measurement tube, said at least one transducer operative to sense vibration of said at least one measurement tube and output electrical signals representative thereof.

2. The Coriolis flow meter of claim 1, further comprising a housing surrounding at least a portion of said flow path.

3. The Coriolis flow meter of claim 2, further comprising measurement electronics disposed within said housing and in electronic communication with said at least one transducer.

4. The Coriolis flow meter of claim 3, wherein, when fluid is flowing through said flow path, said control electronics are operative to calculate the mass flow rate of said fluid based on a deflection of said at least one measurement tube from said predetermined mode of vibration.

5. The Coriolis flow meter of claim 1, wherein said at least one damper element is formed of a thin metal material.

6. The Coriolis flow meter of claim 1, wherein said damper element comprises a rubber tube.

7. The Coriolis flow meter of claim 1, wherein said damper element comprises at least one O-ring.

8. The Coriolis flow meter of claim 1, wherein said damper assembly comprises two damper elements.

9. The Coriolis flow meter of claim 8, wherein one of said damper elements is disposed between said first end structure and said first end of said at least one measurement tube and the other of said damper elements is disposed between said second end structure and said second end of said at least one measurement tube, such that said measurement tube is not fixed with respect to either said first end structure or said second end structure.

10. The Coriolis flow meter of claim 1, further comprising at least one temperature sensor.

11. The Coriolis flow meter of claim 1, further comprising at least one actuator coupled with said at least one measurement tube, said at least one actuator operative to cause said at least one measurement tube to vibrate in a predetermined mode of vibration.

12. A fuel dispenser, comprising:
internal fuel flow piping adapted for connection to a source of fuel from a bulk storage tank to a nozzle;
at least one fuel flow meter located along said fuel flow piping, said at least one fuel flow meter comprising:
a first end structure and a second end structure;
a flow path extending between said first end structure and said second end structure, said flow path comprising at least one measurement tube;
said flow path further comprising a damper assembly disposed between said first end structure and said at least one measurement tube such that said at least one measurement tube is not fixed with respect to said first end structure; and
at least one transducer coupled with said at least one measurement tube, said at least one transducer operative to sense vibration of said at least one measurement tube and output electrical signals representative thereof; and
a control system having a processor in electrical communication with said at least one transducer of said at least one fuel flow meter.

13. The fuel dispenser of claim 12, wherein, when fuel is flowing through said flow path, said control system is operative to calculate the mass flow rate of said fuel.

14. The fuel dispenser of claim 13, wherein said control system is operative to calculate a volume of fuel dispensed during a fueling transaction and display information representative of said volume on a display.

15. The fuel dispenser of claim 12, said at least one fuel flow meter further comprising measurement electronics in electrical communication with said at least one transducer and said control system of said fuel dispenser.

16. The fuel dispenser of claim 15, wherein, when fuel is flowing through said flow path, said measurement electronics is operative to calculate the mass flow rate of said fuel and output information representative thereof to said control system.

17. The fuel dispenser of claim 12, wherein said at least one fuel flow meter comprises a plurality of fuel flow meters.

18. The fuel dispenser of claim 12, wherein said at least one fuel flow meter comprises at least one actuator coupled with said at least one measurement tube, said at least one actuator operative to cause said at least one measurement tube to vibrate in a predetermined mode of vibration.
